(19) United States
(12) Patent Application Publication
(10) Pub. No.: US 2006/0232468 A1
(43) Pub. Date: Oct. 19, 2006

(54) Antenna unit and method of transmission or reception

(75) Inventors: Steve Carl Jamieson Parker, Bristol (GB); Satoshi Mizoguchi, Bristol (GB)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 11/261,516

(22) Filed: Oct. 31, 2005

(30) Foreign Application Priority Data
Feb. 2, 2005 (GB) 0502152.2

(51) Int. Cl. H01Q 3/00

(52) U.S. Cl. 342/359

(57) ABSTRACT

An antenna unit comprising orientation detection means and/or force detection means and an antenna is operable to control its transmission and/or reception characteristic in response to detected orientation of the antenna unit. Absolute orientation of the unit will affect the transmission and/or reception characteristics; in one embodiment changes in orientation and motion will affect these characteristics in order to take account of Doppler effects.

The invention relates to an antenna unit and a method of transmission or reception. In particular, but not exclusively, it relates to an antenna unit capable of being used in a device which is not necessarily intended for use in a given orientation of operation, or which might be used in various different orientations. The invention also relates to a corresponding method of transmission or reception.

Wireless communication systems typically comprise an antenna for the transmission and reception of signals.

Some recent wireless systems use multiple antennas in a communications device to provide multiple-input, multiple output (MIMO) communication between a transmitter and receiver. MIMO systems improve performance in terms of, for example, throughput, link robustness and communication range through spatial multiplexing, or by providing multiple independent copies of the transmitted data. This is generally achieved by use of space-time coding techniques, for example Alamouti orthogonal space-time block coding (see S. M. Alamouti, A Simple Transmit Diversity Technique for Wireless Communications, IEEE Journal on Select Areas in Communications, vol. 16, no. Oct. 8, 1998).

However, other factors also affect performance, such as the signal to noise ratio (SNR) at the receiver used for communication. The SNR is dependent, among other things, on transmitted signal power, path loss through the environment, the gain of the antennas and the noise in the receiver.

In general, the performance of a wireless communications link improves as the total received signal strength increases. However, as antennas generally do not have an omni-directional response, either in transmission or reception, the signal strength and consequently performance become dependent on the orientation of the antenna.

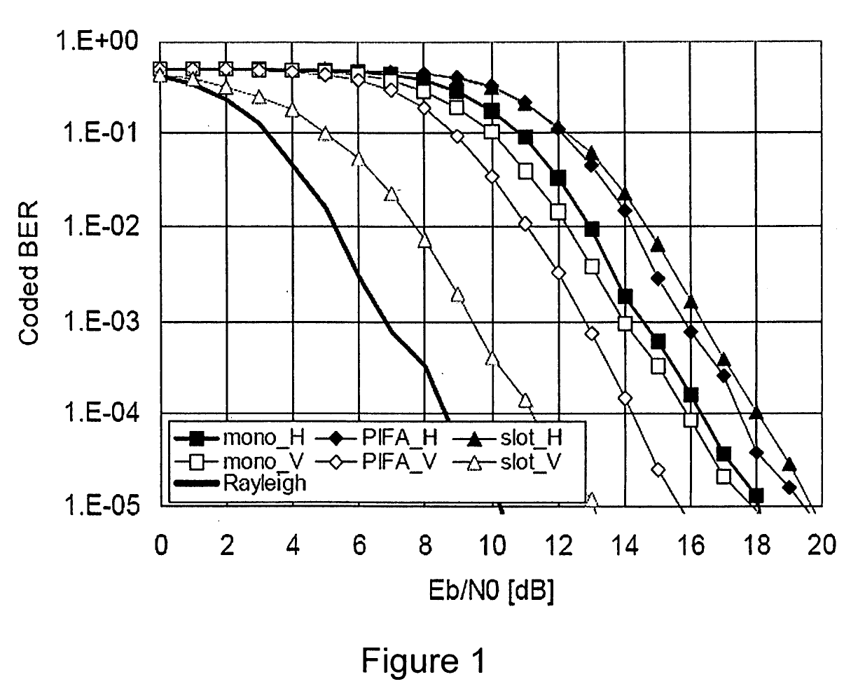

Antennas mounted in mobile communications devices often have a response that varies strongly with their angle of elevation and azimuth, which hence can impact on performance. For example, FIG. 1 shows the coded bit error rate performance versus SNR in a spatially multiplexed MINO system with dual transmit and receive antennas for mono, Planar Inverted-F Antenna (PIFA) and slot antenna types. The legend identifies vertical and horizontal orientations of antennas as_V and_H respectively, and it can be seen from the plots that the change in angle of elevation can dramatically affect the bit error rate.

This was previously not considered a problem, as the orientation of a device was either known, or substantially constant, or a combination of the two. For example, it is a reasonable expectation that a hand held mobile telephony device will be held at a particular orientation, given the position of the earpiece and integral microphone of the device in question. Once the designer of the device has dictated where these two components are to be positioned, then it is possible to determine a suitable orientation for transmission and reception beams at the antenna to allow reasonably good transmission and reception quality.

However, in other devices, the orientation of the device is not so easily dictated by ergonomics. A personal digital assistant (PDA) is a hand held computing device used in general as a personal organiser and which is ergonomically designed to permit use thereof as a diary, notepad or the like. A PDA may have wireless communications capability and, as such, may also be configured as a mobile telephony device. Whether or not the PDA is used as a telephony device as well as a personal organiser, the nature of the device means that it may be used in a variety of configurations and orientations. As such, the expected orientation of the antenna cannot easily be determined by the antenna designer, and so compromise must be sought, either in accepting deleterious performance in certain orientations of the hand held device, or in terms of increased power consumption to ensure acceptable quality transmission and reception at as many orientations as possible.

Certainly, to some extent, the above also applies to the design of antennas for conventional mobile telephony devices, in that the designer is making assumptions concerning the likely orientation of the hand held device in use—it will be appreciated that not all users orient mobile telephony devices in a conventional manner and this may lead to deleterious quality of transmission and/or reception.

Thus, a problem exists concerning the effect of the orientation of antenna equipment on performance.

Accordingly, aspects of the present invention seek to mitigate, alleviate or eliminate the above-mentioned problem.

According to one aspect of the present invention, an antenna unit comprises an orientation detection means and an antenna, the antenna unit being arranged in operation to modify at least one transmission characteristic, in response to detected orientation.

According to another aspect of the present invention, an antenna unit comprises an orientation detection means and an antenna, the antenna unit being arranged in operation to modify at least a first reception characteristic, in response to detected orientation.

In either of the above aspects of the invention, the orientation detection means can comprise elevation detection means, for detecting an angle of elevation, with respect to a given absolute angle of elevation. The given absolute elevation angle may be a vertical axis, with respect to the gravitational field to which the orientation detection means is subject. The elevation detection means may comprise gravitational force detection means for detecting a component of gravitational force resolved in said angle of elevation away from the vertical axis. The gravitational force detection means may comprise an accelerometer comprising a mass and means for detecting the component of gravitational force applied to the mass in inclination of the accelerometer away from the vertical axis.

In either of the above aspects of the invention, the orientation detection means can comprise azimuthal direction detection means, for detecting an azimuthal orientation of the antenna unit, with respect to a given absolute azimuthal direction.

It will be appreciated that the azimuth is itself a relative term, being in relation to a horizontal angle with respect to a compass bearing. In particular, by convention, an azimuthal angle may be measured with respect to a bearing of due North, and specifically magnetic due North.

The azimuthal direction detection means may comprise magnetic field detection means for detecting a magnetic field applied thereto. On the basis that the prevailing magnetic field of the Earth will apply to the azimuthal direction detection means, the direction of this magnetic field can be used to determine the azimuthal orientation of the antenna unit. Of course, it will be appreciated that locally occurring alterations in the magnetic field may cause errors in this detection but, in practice, these occurrences are likely to be infrequent.

The magnetic field detection means may comprise a Hall effect detection means, operable to measure an electric field generated in a conductor placed in the magnetic field, and thereby to determine the relative strength of the component of the magnetic field perpendicular to both the current in the current carrier and the measured electric field.

Similarly advantageously, by detecting the acceleration of the antenna unit, the velocity of the antenna unit can also be determined if a condition at rest is known, as can changes (present or impending) therein, and a transmission or reception characteristic can be modified to mitigate present or impending Doppler shifts.

According to another aspect of the present invention, an antenna unit comprises an orientation detection means and a plurality of antennas, the antenna apparatus being arranged in operation to modify at least a first transmission characteristic in response to detected orientation.

According to another aspect of the present invention, an antenna unit comprises an orientation detection means and a plurality of antennas, the antenna unit being arranged in operation to modify at least a first reception characteristic in response to detected orientation.

In one configuration of either of the above two aspects, the antennas, amongst which one or more may be selected, each occupy a different physical orientation. In use, one or more antennas may be selected in response to a detected change in orientation in order to maintain or establish an effective orientation, wherein the new selected antennas are those oriented to the preceding selected antennas in approximately opposite fashion to the change in physical orientation of the antenna unit.

In another configuration of either of the above two aspects, the antennas, amongst which one or more may be selected, each have a different directional response. In use, one or more antennas may be selected in response to detected orientation in order to maintain or establish an effective orientation.

In another configuration of either of the above two aspects, the plurality of antennas comprises one or more beam forming antennas. In the event that more than one beam forming antenna is provided, the beam forming antennas are preferably operable in co-operation to direct a beam in any specified direction. In use, one or more antennas may be used to modify the transmitted beam pattern in order to maintain an effective orientation, wherein the beam pattern changes to redirect the beam by approximately the opposite extent to that resulting from a detected change in orientation.

In a further configuration of either of the above two aspects, the plurality of antennas comprises one or more beam forming antennas, the beam forming antennas preferably being operable in co-operation to direct a beam in any specified direction. In use, one or more antennas may be used to modify the transmitted beam pattern in order to establish an effective orientation, wherein the beam pattern changes to redirect the beam by a determined angular offset relative to a detected orientation.

According to a further aspect of the present invention, an antenna unit comprises an orientation detection means comprising an acceleration detection means, and a plurality of antennas, the antenna unit being arranged in operation to modify at least a first transmission characteristic in response to detected acceleration or velocity determined from detected acceleration.

In one configuration of this aspect, a processing means is operable to determine the velocity or acceleration, and causes mitigating changes to a modulation and coding scheme used for transmission.

In one configuration of this aspect, the processing means is operable to control changes to any or all of the modulation mode, codec, error protection, signal gain and data rate.

In another configuration of this aspect, the processing means is operable to inform another communication device of the velocity or impending velocity change.

In a further configuration of this aspect, the processing means is operable to request changes to any or all of the modulation mode, codec, error protection, signal gain and data rate from another communication device.

According to a further aspect of the present invention, an antenna unit comprises an acceleration detection means and a plurality of antennas, the antenna unit being arranged in operation to modify at least a first reception characteristic in response to determined velocity or acceleration.

In a configuration of this aspect, the processing means is operable to inform a communication device of impending frequency spread changes likely to affect reception and decoding of Doppler shifted signals.

According to a further aspect of the present invention, a communications device comprises an acceleration detection means and one or more antennas, and communication means operable to communicate information describing desired or actual effective orientation of a beam pattern for use in communication to another communication device.

In one configuration of this aspect, the communications device is operable to transmit information describing the effective orientation to a receiver. In that way, the receiver can use this information to determine a statistically most likely beam orientation for receiving a signal. It will be understood that this may not in fact be the most effective orientation as multipath effects may make another orientation more effective. In a preferred embodiment, the receiver may be operable in accordance with a learning algorithm, which may determine a favoured beam orientation such as through training and past experience. This may be implemented in use with a neural network processing application.

In another configuration of this aspect, the communications device is operable to receive information describing a desired effective orientation from a potential receiver.

In a further configuration of this aspect, the communications device is operable to receive information describing a desired effective orientation via a user interface of the device hosting the antenna unit.

In a yet further configuration of this aspect, the communications device is operable to receive information describing a desired effective orientation from a service related application of the device hosting the antenna unit.

According to another aspect of the present invention, an antenna unit comprises an orientation detection means, a plurality of antennas and a global positioning system (GPS), wherein in use the first motion detection means and the GPS provide data for a display means, enabling navigation by user.

According to another aspect of the present invention, an antenna unit comprises a motion detection means and a plurality of antennas, wherein in use the motion detection means is arranged in operation to trigger an alarm, if the alarm is set.

According to another aspect of the present invention, an antenna unit comprises an orientation detection means comprising an acceleration detection means, and a plurality of antennas, wherein in use acceleration detected by the acceleration detection means is gauged as to whether it is likely to cause damage to the device to which the antenna apparatus is attached or in which it is housed.

It will be appreciated that, in use, positive accelerations of such a magnitude as to cause damage, or to give rise to the significant risk of damage, are unlikely to be experienced by the unit. In contrast, decelerations (negative accelerations) of magnitudes giving rise to the significant risk of damage, may be encountered. Such decelerations could result from a computing device incorporating an antenna unit according to an aspect of the invention being dropped, or being in a vehicle involved in an accident, or simply through misuse by a user (shaking, throwing etc.). It is desirable to be able to detect such decelerations.

According to an aspect of the present invention, an antenna unit comprises an orientation detection means and a plurality of antennas, and recording means operable to record information describing detected forces on the unit in order to provide a record of orientation with respect to the earth's gravitational axis, movement, and acceleration (or deceleration as the case may be).

According to another aspect of the present invention, an antenna unit comprises an orientation detection means and a plurality of antennas, wherein in use detected orientations or changes in orientation are parsed as inputs for use either by the host device or for transmission to a third party.

According to another aspect of the present invention, a mobile communications device comprises an antenna unit in accordance with an aspect of the invention as identified above.

According to another aspect of the present invention, a vehicle comprises an antenna unit in accordance with an aspect of the invention as identified above.

According to another aspect of the present invention, a method of transmission by an antenna unit comprises detecting an orientation of the antenna unit via orientation detection means, and then changing at least a first transmission characteristic in accordance with the determined orientation.

According to another aspect of the present invention, a method of reception by an antenna unit comprises detecting an orientation of the antenna unit via orientation detection means, and then changing at least a first reception characteristic in accordance with the determined orientation.

In one configuration of either of the above two aspects, the change to the transmission or reception characteristics comprises selecting between antennas of the antenna unit.

In another configuration of either of the above two aspects, the change to the transmission or reception characteristics comprises adjusting a beam pattern from one or more antennas of the antenna unit.

In a further configuration of either of the above two aspects, the change to the transmission characteristics comprises adjusting parameters of a modulation and coding scheme.

According to another aspect of the present invention, a computer program product comprises processor implementable instructions, the instructions operable to cause a processing means to carry out those steps of the methods herein applicable to such a processing means.

It will be appreciated that the above aspects of the invention comprise specifically configured apparatus, or processes without reference to apparatus on which the processes are to be performed. It will be understood that the invention can, in accordance with any aspect thereof, be implemented on a general purpose computer configured with suitable communications hardware and corresponding executable program instructions. The executable program instructions may be introduced by means of a carrier medium, which can be a storage medium, for example an optical storage device (e.g. an optical disk) or a suitable carrier signal-medium, such as a data transfer protocol (e.g. FTP over IP) operable to transfer data defining suitable executable program instructions to the apparatus.

Although the present invention has been described hereinabove with reference to a number of separate aspects, in accordance with the present invention, any aspect of the present invention described hereinabove can be used in conjunction with any other aspect of the present invention.

Embodiments of the present invention will now be described by way of example with reference to the accompanying drawings, in which:

FIG. 1 is a graph showing the ratio of energy per bit to the spectral noise density (E_{b}/N_{O}) (i.e. signal to noise ratio) on the X-axis against coded bit error rate (BER) on the Y-axis, for a selection of antenna types and antenna orientations, as described in the introduction above.

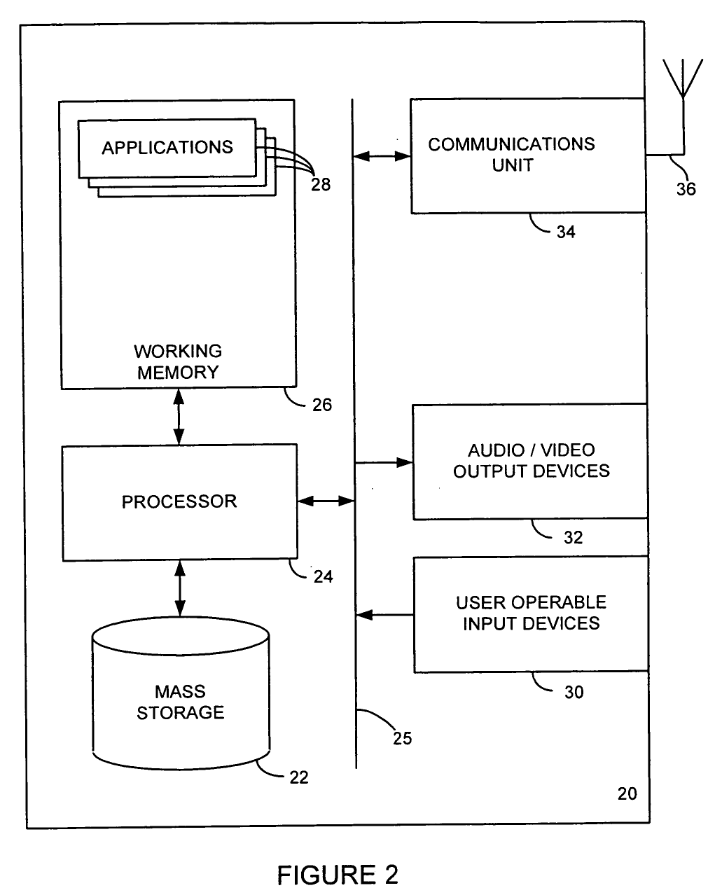

FIG. 2 is a schematic diagram of a communication device known in the art.

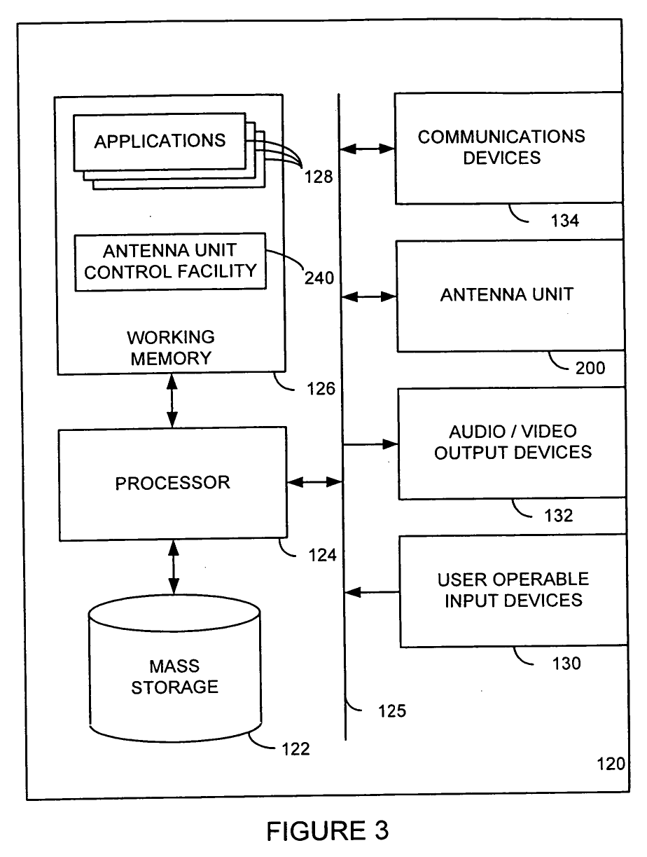

FIG. 3 is a schematic diagram of a communication device in accordance with an embodiment of the present invention.

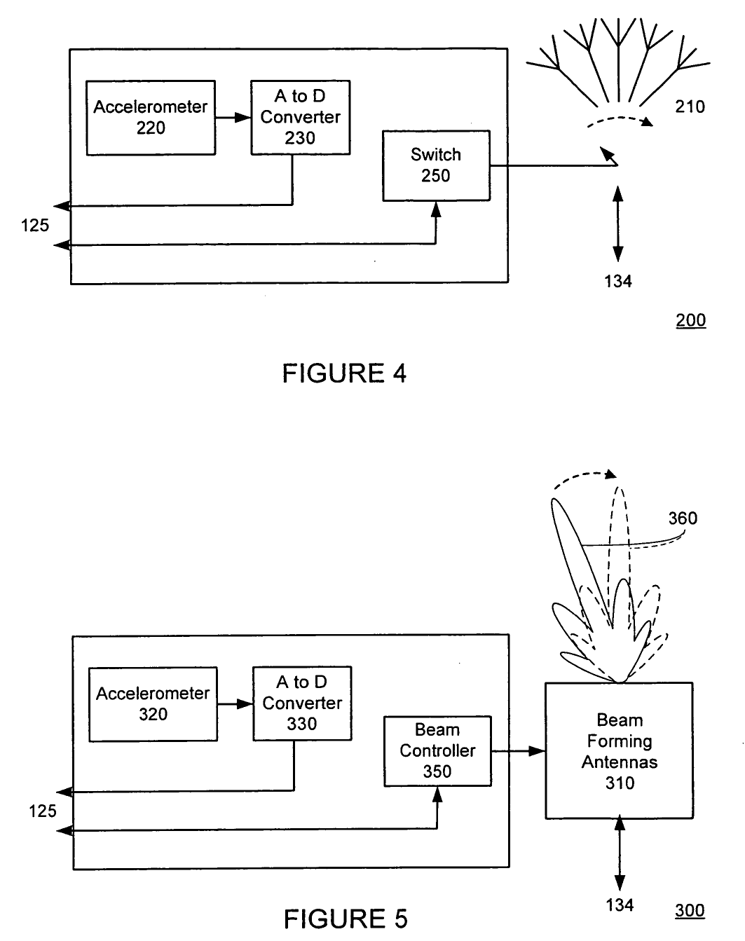

FIG. 4 is a schematic diagram of an antenna unit in accordance with a first embodiment of the present invention.

FIG. 5 is a schematic diagram of an antenna unit in accordance with a second embodiment of the present invention.

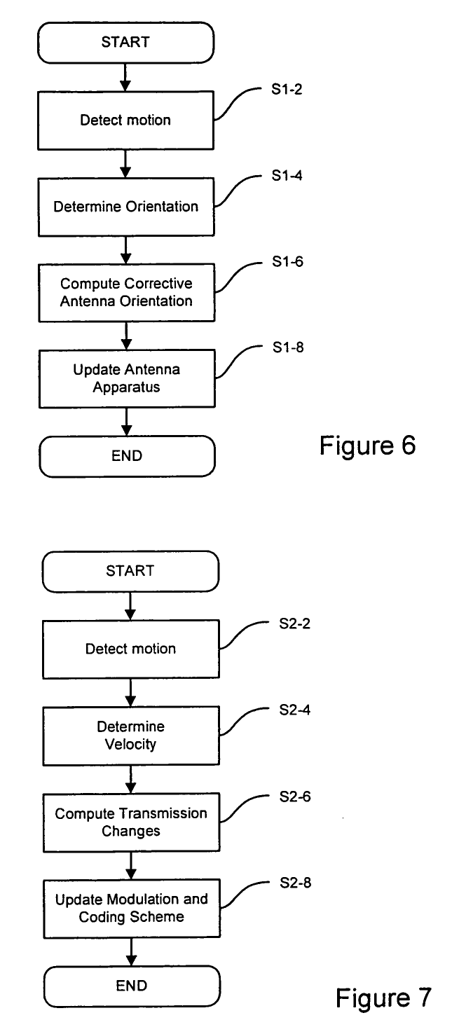

FIG. 6 is a flow diagram of a method in accordance with an embodiment of the present invention.

FIG. 7 is a flow diagram of a method in accordance with an embodiment of the present invention.

An antenna unit and method of transmission or reception is disclosed. In the following description, a number of specific details are presented in order to provide a thorough understanding of embodiments of the present invention. It will be apparent, however, to a person skilled in the art that these specific details need not be employed to practice the present invention.

FIG. 2 illustrates schematically a personal digital assistant (PDA) device 20 known in the art. The PDA device 20 comprises a processor 24 operable to execute machine code instructions stored in a working memory 26 and/or retrievable from a mass storage device 22. By means of a general-purpose bus 25, user operable input devices 30 are in communication with the processor 24. The user operable input devices 30 comprise, in this example, a pointing device in cooperation with a contact sensitive surface on a display unit of the device, but could include a mouse or other pointing device, a keyboard, a writing tablet, speech recognition means, or any other means by which a user input action can be interpreted and converted into data signals.

Audio/video output devices 32 are further connected to the general purpose bus 25, for the output of information to a user. Audio/video output devices 32 include a visual display unit, and a speaker, but can also include any other device capable of presenting information to a user.

It will be appreciated that audio/visual input devices such as a camera or microphone could be incorporated into, or connected with, the PDA device 20.

A communications unit 34 is connected to the general purpose bus 25, and further connected to an antenna 36. By means of the communications unit 34 and the antenna 36, the PDA device 20 is capable of establishing wireless communication with another device. The communications unit 34 is operable to convert data passed thereto on the bus 25 to an RF signal carrier in accordance with a communications protocol previously established for use by a system in which the PDA device 20 is appropriate for use.

In the device 20 of FIG. 2, the working memory 26 stores user applications 28 which, when executed by the processor 24, cause the establishment of a user interface to enable communication of data to and from a user. The applications 28 thus establish general purpose or specific computer implemented utilities and facilities that might habitually be used by a user.

In contrast, FIG. 3 illustrates a PDA device 120 in accordance with an embodiment of the present invention. In most respects, the PDA device 120 is of similar construction to that illustrated in FIG. 2, and reference numerals therefore correspond, with a prefixed ‘1’ to distinguish. FIG. 3 comprises a general representation which encompasses features common to first and second specific embodiments to be described below.

In contrast to the PDA device 20 illustrated in FIG. 2, the PDA device 120 comprises an antenna unit 200 operable to communicate with other components of the PDA device 120 via bus 125. A communications unit 134 communicates with the antenna unit 200 to establish wireless communication with another device.

In working memory 126, antenna unit control facility 240 comprises instructions executable by the processor 124 to provide processing means suitable for controlling the antenna unit 200.

Referring to FIG. 4, in the presently described first embodiment of the present invention, the antenna unit 200 comprises an accelerometer 220, an analogue to digital converter 230, a switch 250 and a plurality of antennas 210. The accelerometer 220 is operable to detect orientation of the antenna unit 200 relative to the vertical (in which direction the action of gravity is oriented), and also acceleration of the antenna unit 200, and thereby information concerning accelerated or decelerated motion of the antenna unit 200. The accelerometer 220 is operably coupled to the processor 124 via bus 125, and typically via A to D converter 230.

The processor 124, executing the antenna unit control facility 240, is in turn operable to control the switch 250. The switch 250 enables selection amongst the plurality of antennas 210, so affecting the directional transmission or reception of signals.

In use, the processor 124, under instruction from the antenna unit control facility 240, interprets the information it receives from the accelerometer 220 to determine the orientation and in particular the elevation of the antenna unit as a consequence of the effect of gravitational force on the accelerometer 220. The determining process assumes a known relative orientation between the antenna unit 200 and the accelerometer 220.

If a change in orientation is detected, the processor 124 then causes the switch 250 to select at least a first antenna from the plurality of antennas 210 that best compensates for the determined change of orientation.

The plurality of antennas 210 within the antenna apparatus 200 together occupy a range of orientations relative to the accelerometer 220, in the present embodiment forming a fan of antennas spread in one plane over 90 degrees, as shown in FIG. 4.

Thus, for example, if a first antenna is currently selected for use, and the PDA device 120 is then tilted by thirty degrees in one direction, then the processor 124, under instruction from antenna unit control facility 240, will select, from among the plurality of antennas 210, that antenna oriented closest to thirty degrees in the other direction from the first antenna, thus providing compensation for the physical tilt. Note that, for relatively small motions, the first antenna may still be selected as the closest to the original orientation.

It will be clear to a person skilled in the art that the plurality of antennas 210 may occupy a range of orientations encompassing any portion of a sphere, for example a set of radially aligned antennas distributed over a hemisphere.

Similarly it will be clear to a person skilled in the art that, alternatively or in addition, the plurality of antennas 210 may have distinct directional response profiles wherein the signal transmission/reception strength of an antenna varies as a function of direction with respect to the antenna, and that these profiles can be factored in to antenna selection.

Referring now to FIG. 5, in a second embodiment of the present invention, an antenna unit 300 comprises an accelerometer 320 operable to detect forces on the unit through orientation or acceleration, an analogue to digital converter 330, a beam controller 350 and one or more adjustable beam-forming antennas 310. The accelerometer 320 is operably coupled to the processor 124 via bus 125, and typically via A to D converter 330.

In normal use, the or each beam-forming antenna 310 is configured by the beam controller 350 to form a beam pattern 360. The beam pattern 360 is illustrated oriented in a nominal direction, marked in a solid line. Where more than one beam-forming antenna is provided, they may be phased appropriately to provide a desired beam pattern in a desired orientation direction.

In use, the processor 124, under instruction from antenna unit control facility 240, interprets the information it receives from accelerometer 320 to determine the orientation, and in particular the elevation, of the antenna unit as a consequence of the effect of the component of force on the accelerometer due to gravity on the accelerometer 320. The determining process assumes a known relative orientation between the antenna unit 300 and the accelerometer 320.

The processor 124, under instruction from antenna unit control facility 240, is then operable to determine a change in orientation, and in particular elevation. The processor 124 then causes the beam pattern 360 generated by the adjustable beam-forming antennas 310 to change in the opposite direction, in order to compensate for the detected motion. This new direction is illustrated in FIG. 5 by a beam pattern outlined in a broken line, and the adjustment of the beam orientation is noted by the broken arrow illustrated above the two examples of the beam pattern orientation.

The processor 124 causes the change in beam pattern 360 via instructions to the beam controller 350.

Thus, for example, if a first beam pattern 360 is currently in use and the PDA device 120 is then tilted by thirty degrees in one direction, the processor 124 under instruction from antenna unit control facility 240 will cause the beam pattern 360 to move as close as possible to thirty degrees in the other direction, thus providing compensation for the physical tilt.

Clearly, this action may be interpreted either as compensating for the thirty-degree change in orientation, or as responding to a new absolute orientation that differs by thirty degrees to the previous one.

It will be clear to a person skilled in the art that the beam controller 350 may employ various means to adjust the orientation of the beam, such as a programmable loaded parasitic structure, or multiple feed points to the adjustable beam-forming antennas 310.

It will also be clear to a person skilled in the art that beam-forming antennas 310 may co-operate to generate beam patterns. It will similarly be clear that sufficient beam forming antennas 310 may be arranged to provide coverage in any orientation, including ranges of angles of azimuth and elevation.

Determining the angle of azimuth of the antenna unit can be arranged by simple modification of either of the illustrated embodiments, by additionally including a Hall effect electronic compass with which the antenna unit can determine its orientation with respect to the surrounding magnetic field. On the basis that the surrounding magnetic field will generally be substantially influenced by the magnetic field of the Earth, the compass direction, or azimuthal orientation, of the unit can be derived. It will be appreciated that the use of a Hall effect electronic compass is merely one example of the means by which the azimuth direction can be determined, and other means could also be used. Further, it will be understood that the determination of this azimuthal orientation may be sufficient to produce improvement in orientation of a beam, without determination of elevation direction so the provision of an electronic compass may be as an alternative to the accelerometer of the embodiments described above.

It will be further clear to a person skilled in the art that different applications may benefit from different beam patterns, and so these patterns may be defined in advance and stored in a table associating services, service providers and/or receivers with beam patterns, or may be defined on demand. Alternatively beam patterns may be derived empirically or by a self-learning system.

In FIG. 6, the method employed by antenna unit 200, 300 in the above two embodiments is shown. In step S1-2, the accelerometer 220, 320 indicates a force applied to the calibrated mass mounted in the accelerometer in the measured direction due to an angle of elevation (by virtue of gravity) or acceleration of the accelerometer. The resulting output passes to processor 124, which, under instruction from antenna unit control facility 240, determines the resulting angle of elevation in step S1-4. The processor 124 then computes in step S1-6 a corrective beam orientation, typically responsive to the orientation determined during step S1-4. The processor 124 then causes the beam of the antennas 210, 310 to be updated to this new corrective orientation in step S1-8.

It will be understood that the operation of the antenna unit 200, 300 may include discerning a preferred direction on the basis of history of communication with a particular other communications device.

As noted previously, antennas may be updated by selection from a plurality of antennas 210, or by modification of a beam pattern 360. Whereas the first illustrative embodiment indicates the use of a set of antennas oriented in different directions, to allow selection of one thereof for use at a particular time, it will be appreciated that this embodiment has been described first for illustration only—in practice it may be technically more feasible to employ the second, beam steering example of the invention as this may require no moving parts.

Referring now to FIGS. 3 and 5, in a third embodiment of the present invention, the antenna unit 300 comprises an accelerometer 320 operable to detect acceleration and angle of elevation, an analogue to digital converter 330, a beam controller 350 and one or more adjustable beam-forming antennas 310. The accelerometer 320 is operably coupled to the processor 124 via bus 125, and typically via A to D converter 330.

In use the processor 124, under instruction from antenna unit control facility 240, interprets the information it receives from accelerometer 320 over a period of time to determine the velocity of the antenna unit. It will be understood that the absolute velocity of the unit or, more correctly, the velocity of the unit relative to an earth-mounted reference frame, is only calculable if an initial condition is available. Otherwise, only relative velocity of the unit with respect to a starting point is derivable. The processor 124, under instruction from antenna unit control facility 240, then causes an adjustment to the transmission or reception of data to compensate for Doppler effects.

For transmission, adjustment occurs by changing the modulation and coding scheme employed in communications unit 134. The modulation and coding scheme may comprise the mode of modulation, the parameters of the codec, the data transmission rate, transmitted signal power and, as the case may be, the forward error correction code in use, and the type of space time code (MIMO) in use.

It will be clear to a person skilled in the art that the processor 124, under instruction from antenna unit control facility 240, may control this adjustment; for example by changing to a lower quadrature amplitude modulation (QAM) scheme, such as from 64 QAM to 16 QAM, or other methods of altering the data transmission rate.

It will similarly be clear to a person skilled in the art that the processor 124 may otherwise inform the communications unit 134 of the determined velocity, or send to communications unit 134 a request to modify suitable aspects of the modulation and coding scheme itself. In the case where determined velocity is used to detect the possibility of Doppler effects, and the need to mitigate for them, it will be appreciated that it may be sufficient to determine the relative velocity of two communications units in order to determine the possibility of Doppler effects between them: the sufficiency of this may need to be assessed depending on the impact of multipath effects in the situation at the time.

It will also be clear to a person skilled in the art that other features of the modulation and coding scheme, such as redundancy in the codec, may be controlled in any suitable combination.

For reception, adjustment occurs by informing communications unit 134 of any frequency spread modifications required to account for Doppler effects in received signals. It will be appreciated that this adjustment is not in itself a compensation process for Doppler effects. The present invention mitigates for Doppler effects, rather than providing compensation. The communications unit 134 is configured to react to the possible existence of Doppler effects, for example by resorting to a lower data transmission rate.

It will be clear to a person skilled in the art that, for either transmission or reception, in addition to velocity, the acceleration may also be interpreted to enable predictive Doppler mitigation.

In FIG. 7, the method employed by antenna unit 200, 300 in the above embodiment is shown. Accelerometer 220, 320 indicates acceleration in step S2-2. The resulting output passes to processor 124, which, under instruction from antenna unit control facility 240, determines the resulting velocity due to the motion in step S2-4, for example by integration of the detected acceleration from a time when the PDA device 120 was known to be at rest. The processor 124 then determines in step S2-6 mitigating changes to transmission or reception characteristics, and causes these to be applied to the modulation and coding scheme in step S2-8. This arrangement thus provides warning and pre-emptive action for impending changes in velocity—there is no requirement for changes in velocity to firstly be detected and then reacted to. Instead, this arrangement allows the unit to anticipate changes in velocity by monitoring acceleration.

As noted previously, changes to the modulation and coding scheme may comprise choice of modulation mode, codec (codec type or parameters thereof), codec redundancy, transmit signal power and data rate. The processor 124 may have direct control of some or all of these changes, or interact with the communications unit 34 to elicit changes. As also noted previously, the use of velocity in step S2-4 may instead of or in addition include the use of acceleration.

In a further embodiment of the invention, processor 124, under instruction from antenna unit control facility 240, instructs transmission of data indicating the effective orientation of the antenna unit. The effective orientation is the combination of the physical orientation of the antenna unit 200, 300, due for example to the position of the PDA device 120, together with a compensating selection of antennas 210 or alteration to beam pattern 360, depending on the implementation in use. The PDA communicates the orientation of its beam pattern to a device with which it is likely to communicate in the future.

Where the compensation exactly accounts for the physical orientation, the effective orientation remains the same as it was prior to the physical movement. However, in an instance where the compensation does not exactly correspond, such as if no selected antenna position happens to exactly compensate for the physical movement, then the effective orientation of the antenna apparatus 200, 300 will no longer be exactly as it was prior to the physical movement. Transmitting the effective orientation may therefore give a transceiver the opportunity of reconfiguring its own transmission or reception characteristics to compensate for this change, in advance of further communication. It will be appreciated that this process is intended to determine and use the most appropriate mutual alignment of two terminals. It is not necessarily limited to the selection of line of sight alignments, as such alignments may not be possible, or may be inappropriate given other environmental effects.

Alternatively or in addition, the preferred effective orientation can be specified by a user, through a user operable input device 130 providing suitable input means.

It will be clear to a person skilled in the art that preferred effective orientations could be stored in a table associating services, service providers and/or receivers with orientations, or could be provided by service-specific applications on the PDA device 120, or could be learned by a self-learning system.

In an enhanced embodiment of the present invention the antenna unit 300, comprising an accelerometer 320 operable to detect angle of elevation and/or azimuth orientation, an analogue to digital converter 330, a beam controller 350 and one or more adjustable beam-forming antennas 310, further comprises a global positioning system (not shown) and an electronic compass (not shown). The electronic compass may be of any known type, such as a detector employing the Hall effect. In addition, an application 128 is provided, configured to provide navigation facilities.

The relative azimuthal alignment of two communications devices can thus be determined and a method of beam steering can be used to optimise beam direction in a line of sight scenario. This is achieved simply by pointing beams at each other. Alternatively training or past performance can be used to determine optimum angles of alignment if a line of sight does not exist.

The processor 124, under instruction from the navigation application 128, is operable to interpret outputs of the GPS and digital compass to determine a desired direction, and indicate said direction via an audio/video output device 132 in a suitable manner.

In an enhanced embodiment of the present invention the antenna unit 300 comprises an accelerometer 320 operable to detect acceleration, an analogue to digital converter 330, a beam controller 350 and one or more adjustable beam-forming antennas 310, wherein the accelerometer 320 is arranged in operation to trigger an alarm (not shown), if the alarm is set. In so doing, it provides an anti-theft or slippage alert feature. In an alternative embodiment, a password-controlled lockout is triggered as an anti-theft feature.

In an enhanced embodiment of the present invention, the antenna unit 300 comprises an accelerometer 320 operable to detect acceleration, an analogue to digital converter 330, a beam controller 350 and one or more adjustable beam-forming antennas 310. In addition, an application 128 is provided, configured to provide monitoring facilities.

The processor 124, under instruction from the monitoring application 128, is operable to gauge detected accelerations likely to cause damage to the antenna unit 300 or PDA device 120, for example if the PDA device 120 is dropped.

This provides a means to determine if a user is mistreating the PDA device and to manage the situation, for example by initially notifying the user of the event via suitable audio/video output devices 132, and subsequently wirelessly notifying a third party if the event occurs again to a defined extent and/or over a defined period.

In an enhanced embodiment of the present invention the antenna unit 300 comprises an accelerometer 320 operable to detect acceleration, an analogue to digital converter 330, a beam controller 350 and one or more adjustable beam-forming antennas 310. In addition, an application 128 is provided, configured to provide recording facilities.

The processor 124, under instruction from recording application 128, is operable to record detected motion for the purpose of providing information concerning motion in the event of a crash. This ‘black box’ function records events that may be of use, for example, in a police investigation or insurance claim, but beneficially within the host device, so providing a personal record not associated with, for example, any recording feature inherent in a vehicle.

It will be clear to a person skilled in the art that such a record may be kept in working non volatile memory 126, on mass storage 122, or on a peripheral storage device (not shown).

In an enhanced embodiment of the present invention the antenna unit 300 comprises an accelerometer 320 operable to detect motion, an analogue to digital converter 330, a beam controller 350 and one or more adjustable beam-forming antennas 310. In addition, an application 128 is provided, configured to provide input parsing facilities.

The processor 124, under instruction from the input parsing application 128, is operable to parse motions detected by accelerometer 320 as inputs suitable either for the PDA device 10, or for transmission to a third party.

It will be clear to a person skilled in the art that any combination of the above enhanced embodiments may be used in conjunction with any of the preceding embodiments.

In any of the embodiments disclosed herein, it will be clear to a person skilled in the art that the accelerometer 220, 320 may be replaced or complemented by any or all of the following as applicable;
i. an inertial tracker;
ii. a gyroscope, and;
iii. a tilt switch,
   or any suitable orientation detection means, where any or all of these may be configured to operate in one or more axes, or substantially omnidirectionally. For the avoidance of doubt, an inertial tracker may include an accelerometer, but may alternatively be implemented by means of multi-plane radar or ultrasound to provide orientation detection.

It will similarly be clear to a person skilled in the art that the above orientation detection means may be further augmented by a magnetic sensor or compass.

In any of the embodiments provided-herein, it will also be clear to a person skilled in the art that the communications unit 134 may be in direct communication with antenna unit 200, 300, or via bus 125 or further via processor 124.

It will also be clear to a person skilled in the art that an accelerometer or other orientation detection means providing a digital output will not require an A to D converter.

It will also be clear to a person skilled in the art that the compensation described for the change of the antenna unit 200, 300 to a new orientation can advantageously mitigate changes to performance caused by the physical change in orientation of the antenna for both transmission and reception simultaneously.

It will also be clear to a person skilled in the art that the antenna unit control facility 240 may be provided by a suitably configured application 128 operable in working memory. Similarly, it will be clear that the antenna unit control facility 240 optionally need only comprise those instructions required in fulfilment of a given embodiment of the invention.

It will be clear to a person skilled in the art that in any of the embodiments provided herein, the host device may be a wireless communications device such as a laptop, or a general computer, mobile phone, input device or entertainment device.

In the event that a laptop is used, the antenna unit 200 may be of a PCMCIA format, inserted into a corresponding port of the laptop.

Alternatively, the host device may be or be part of a vehicle such as a car, emergency services vehicle, or boat. Such vehicles often experience changes in elevation, typically predominantly along the longitudinal axis of the vehicle, for example due to traversing hills or waves respectively. In the case of emergency vehicles and boats in particular, there is a great need for reliable antenna response in such conditions that, advantageously, aspects of the present invention seek to facilitate.

The present invention may be implemented in any suitable manner to provide suitable apparatus or operation. An embodiment may consist of a single discrete entity added to a conventional host device such as a laptop, multiple entities added to a conventional host device, or may be formed by adapting existing parts of a conventional host device. Alternatively, a combination of additional and adapted entities may be envisaged. For example, processing means may reside within the PDA device 120 or within the antenna unit 200, 300, or processing may be shared between processing means of both. Thus adapting existing parts of a conventional host device may comprise for example reprogramming of one or more processors therein. As such the required adaptation may be implemented in the form of a computer program product comprising processor-implementable instructions stored on a storage medium, such as a floppy disk, hard disk, PROM, RAM or any combination of these or other storage media or signals.

By way of example, an antenna apparatus comprising a micro electromechanical (MEMS) solid state single-axis accelerometer, such as the ADXL105 from Analog Devices, will determine orientation and angle of elevation in the direction of the accelerometer's measurement axis.

Further, the described embodiments have been used to exemplify the invention in terms of transmitters and receivers. However, it will be appreciated that wireless communications units will be presented which offer the function, in combination, of a transmitter and a receiver, and it will be appreciated that the intention in separating these functions out was for reasons of clarity, and not with any implication as to the exclusivity of these functions.

It will be understood that the antenna unit and method of transmission or reception as described above, provide one or more of the following advantages:
i. Proactive self alignment of an antenna apparatus;
ii. Proactive mitigation for and reaction to impending and actual physical motion of an antenna apparatus, including reacting to the potential existence of Doppler effect distortion of received signals;
iii. Determination of a preferred effective orientation for an antenna apparatus;
iv. Informing another party of an effective orientation for an antenna apparatus;
v. Determining whether movement of a device denotes input data;
vi. Determining whether a device is being moved illicitly or dangerously; and
vii. Recording forces for aiding in a crash investigation.

1. An antenna unit for connection with a communications device, for use in establishing wireless communication between said communications device and a further device, the antenna unit comprising an accelerometer operable to detect orientation with respect to gravity and a first antenna, the antenna unit being arranged in operation to modify at least a first transmission characteristic in response to detected orientation.

2. An antenna unit for connection with a communications device, for use in establishing wireless communication between said communications device and a further device, the antenna unit comprising at least an accelerometer operable to detect orientation with respect to gravity and at least a first antenna, the antenna unit being arranged in operation to modify at least a first reception characteristic in response to detected orientation.

3. An antenna unit according to claim 1, comprising modification means to modify transmission characteristics, said means operable to adjust a modulation and coding scheme in response to any or all of the following:
a determined velocity of the antenna unit; and
a detected acceleration of the antenna unit, for the purpose of mitigating for Doppler effects in transmission or reception.

4. An antenna unit according to claim 1, further comprising modification means to modify transmission or reception characteristics, said means including any or all of the following;
selection means for selecting amongst a plurality of antennas of the antenna apparatus, and;
adjustable beam forming means.

5. An antenna unit according to claim 4 wherein one or more antennas are selectable in response to a detected orientation of the antenna unit, for the purpose of selecting or maintaining an effective beam orientation.

6. An antenna unit according to claim 4 wherein the beam forming means is adjustable in response to a detected orientation of the antenna unit, for the purpose of selecting or maintaining an effective beam orientation.

7. An antenna unit according to claim 6 wherein the beam forming means is adjustable by means of any or all of the following:
multiple feed points; and
programmable lumped parasitic elements.

8. An antenna unit according to claim 3 wherein adjustment to the modulation and coding scheme may comprise any or all of the following:
adjustment of data rate;
adjustment of transmitted signal power;
adjustment of modulation mode;
adjustment of codec parameters;
adjustment of error protection scheme; and
adjustment of type of decoder used.

9. An antenna unit according to claim 1 arranged in operation to communicate with communication hardware of a radio communication system in response to a detected orientation, for the purpose of compensating for said orientation.

10. An antenna unit according to claim 1 wherein one or more antennas of the antenna unit occupy different physical orientations relative to another antenna of the antenna unit.

11. An antenna unit according to claim 1 wherein each antenna of the antenna unit has a directional response profile which is different from at least one other antenna of the antenna unit.

12. An antenna unit according to claim 1 further arranged in operation to initially configure itself in response to detected orientation for when a transmission or reception is first made.

13. An antenna unit according to claim 1 further comprising means arranged in operation to cause data to be transmitted indicating the effective beam orientation of the antenna unit.

14. An antenna unit according to claim 1 further comprising means arranged in operation to receive data indicating the desired effective beam orientation of the antenna unit.

15. An antenna unit according to claim 1 further comprising input means arranged in operation to enable a user to set the desired effective beam orientation of the antenna unit.

16. An antenna unit according to claim 1 wherein the antenna unit further comprises a global positioning receiver.

17. An antenna unit according to claim 16 and wherein the orientation detection means comprises a magnetic sensor.

18. An antenna unit in accordance with claim 17 arranged in operation to send positional data and compass information to a navigation means, for determining a desired direction.

19. An antenna unit in accordance with claim 18 operable to receive positional data and compass information from a corresponding device, and operable to orient transmission and reception beams with respect to said received data.

20. An antenna unit according to claim 1 wherein the antenna apparatus is arranged in operation to facilitate multiple input, multiple output communications.

21. An antenna unit according to claim 1 wherein the orientation detection means is arranged in operation to trigger an alarm, if said alarm is set.

22. An antenna unit according to claim 1 and comprising processing means arranged in operation to gauge whether detected motion of the device is likely to cause damage.

23. An antenna unit according to claim 22 arranged in operation to initially notify the user in the event that the processing means determines that detected motion of the device is likely to cause damage, and thereafter to notify a third party for any or all of the following reasons:
such motion occurs again to a defined extent, and;
such motion occurs again over a defined period.

24. An antenna unit according to claim 1 wherein a processing means is further arranged in operation to parse detected orientations as input for use either by a host device or for transmission to a third party.

25. An antenna unit according to claim 1 wherein the orientation detector is an accelerometer, and further comprising recording means arranged in operation to monitor the output of the accelerometer, for the purpose of providing information concerning motion in the event of a crash.

26. A mobile communication device comprising the apparatus of claim 1.

27. A mobile communication device according to claim 26 wherein the mobile communication device is any one of a laptop, a computer, a PDA, a mobile phone, input device, and an entertainment device.

28. A vehicle comprising the apparatus of claim 1.

29. A method of transmission or reception by an antenna apparatus, the method comprising the steps of:
detecting an acceleration of the antenna apparatus, and;
modifying at least a first transmission or reception characteristic of the antenna apparatus in response to a determined orientation.

30. A method of transmission by an antenna apparatus according to claim 29, wherein the step of modifying the transmission characteristics further comprises adjusting parameters of a modulation and coding scheme in response to any or all of:
the determined velocity of the apparatus; and
the detected acceleration of the apparatus, for the purpose of mitigating for Doppler effects.

31. A method of transmission or reception by an antenna apparatus according to claim 29, wherein the step of modifying the transmission or reception characteristics further comprises any or all of the following steps:
selecting amongst a plurality of antennas of the antenna apparatus, and;
adjusting a beam pattern from one or more antennas of the antenna apparatus.

32. A method of transmission or reception by an antenna apparatus according to claim 31 wherein the step of selecting one or more antennas is responsive to the detected orientation of the antenna apparatus, for the purpose of selecting or maintaining a transmission orientation.

33. A method of transmission or reception by an antenna apparatus according to claim 31 wherein the step of adjusting the beam pattern from one or more antennas of the antenna apparatus is responsive to the detected orientation of the antenna apparatus, for the purpose of selecting or maintaining a transmission orientation.

34. A computer program product comprising processor implementable instructions to cause a processing means to carry out those steps of the method of claim 29.

35. A storage medium storing processor implementable instructions to cause a processing means to carry out those steps of the method of claim 29.

36. A signal carrying processor implementable instructions to cause a processing means to carry out those steps of the method of claim 29.
